(19) United States
(12) Patent Application Publication
(10) Pub. No.: US 2026/0252052 A1
(43) Pub. Date: Aug. 27, 2026

(54) METHOD AND SYSTEM FOR SELECTIVE CRYSTALLIZATION DURING 3D PRINTING

(71) Applicant: INTERNATIONAL BUSINESS MACHINES CORPORATION, Armonk, NY (US)

(72) Inventors: Aaron Keith Baughman, Cary, NC (US); Carolina Garcia Delgado, Zapopan (MX); Tushar Agrawal, West Fargo, ND (US); Sarbajit Kumar Rakshit, Kolkata (IN)

(21) Appl. No.: 19/064,054

(22) Filed: Feb. 26, 2025

(51) Int. Cl. G05B 19/4093; B22F 10/85; B28B 17/00; B29C 64/393; B33Y 50/02

(52) U.S. Cl. CPC G05B 19/40931; B22F 10/85; B28B 17/0081; B29C 64/393; B33Y 50/02; G05B 2219/49023

(57) ABSTRACT

Systems, methods, and computer program products for printing a 3D crystalline article are disclosed. A method comprises reading a specification of a material and a desired crystalline structure. A layer of the material is dispensed by a nozzle. A plurality of materials characteristic sensors determines at least one characteristic of the dispensed layer. A plurality of seed crystals are selected based on a compatibility with the at least one characteristic of the dispensed layer. The compatibility corresponds to an ability of the plurality of seed crystals to produce the desired crystalline structure. The plurality of seed crystals are deposited onto a surface of the layer of material by a robotic arm, thereby producing a portion of the 3D crystalline article.

### BACKGROUND

Embodiments of the present disclosure relate to selectively 3D printing a crystalline article, and more specifically, to a method, system, and computer program product for placing seed crystals on the layers of 3D printed articles during their formation.

3D printing is a known method for manufacturing articles. However, it may be difficult to control the crystalline structure of an article during a 3D printing process. Defects and deformities in the crystalline structure of a 3D printed article may result in undesirable properties (e.g., brittleness). Thus, there exists a need in the art for a system and method for selectively controlling the crystalline structure of an article produced during a 3D printing process.

### BRIEF SUMMARY

According to embodiments of the present disclosure, systems, methods of, and computer program products for selectively 3D printing a crystalline article are disclosed. In various embodiments, a method for printing a 3D crystalline article is provided. A specification of a material and a desired crystalline structure is read. A layer of the material is dispensed by a nozzle. At least one characteristic of the dispensed layer is determined by a plurality of materials characteristic sensors. A plurality of seed crystals is selected based on a compatibility with the at least one characteristic of the dispensed layer. The compatibility corresponds to an ability of the plurality of seed crystals to produce the desired crystalline structure. The plurality of seed crystals are deposited onto a surface of the layer of material by a robotic arm, thereby producing a portion of the 3D crystalline article.

In various embodiments, the at least one characteristic of the dispensed layer includes at least one of a thermal expansion, a melting point, and a viscosity.

In various embodiments, depositing the plurality of seed crystals comprises depositing the plurality of seed crystals in a pattern and using a timing sequence that produces the desired crystalline structure in the layer of material.

In various embodiments, the method further comprises continuously monitoring a crystal formation pattern of the 3D crystalline article during its formation.

In various embodiments, selecting the plurality of seed crystals comprises selecting a type of the plurality of seed crystals from a knowledge database of suitable seed crystal types, wherein the knowledge database comprises data collected from previously printed 3D crystalline articles.

In various embodiments, the method further comprises providing a recommended specification for printing a subsequent 3D crystalline article based on the data collected from previously printed 3D crystalline articles stored in the knowledge database.

In various embodiments, the method further comprises evaluating 3D crystalline article, wherein the evaluation comprises determining at least one characteristic of the 3D crystalline article and storing the results of the evaluation in a knowledge database.

In various embodiments, a system for printing a 3D crystalline article is provided. A nozzle configured to dispense a layer of a material, a robotic arm configured to place at least one seed crystal, a plurality of materials characteristic sensors, and a computing node, communicatively coupled to the nozzle, the robotic arm, and the plurality of materials characteristic sensors is provided. The computing node comprises a computer readable storage medium having program instructions embodied therewith. The program instructions executable by a processor of the computing node to cause the processor to perform a method comprising the following steps. A specification of a material and a desired crystalline structure is read. A layer of the material is dispensed by a nozzle. At least one characteristic of the dispensed layer is determined by the plurality of materials characteristic sensors. A plurality of seed crystals is selected based on a compatibility with the at least one characteristic of the dispensed layer. The compatibility corresponds to an ability of the plurality of seed crystals to produce the desired crystalline structure. The plurality of seed crystals are deposited onto a surface of the layer of material by the robotic arm, thereby producing a portion of the 3D crystalline article.

In various embodiments, the at least one characteristic of the dispensed layer includes at least one of a thermal expansion, a melting point, and a viscosity.

In various embodiments, depositing the plurality of seed crystals comprises depositing the plurality of seed crystals in a pattern and using a timing sequence that produces the desired crystalline structure in the layer of material.

In various embodiments, the method further comprises continuously monitoring a crystal formation pattern of the 3D crystalline article during its formation.

In various embodiments, selecting the plurality of seed crystals comprises selecting a type of the plurality of seed crystals from a knowledge database of suitable seed crystal types, wherein the knowledge database comprises data collected from previously printed 3D crystalline articles.

In various embodiments, the method further comprises providing a recommended specification for printing a subsequent 3D crystalline article based on the data collected from previously printed 3D crystalline articles stored in the knowledge database.

In various embodiments, the method further comprises evaluating the 3D crystalline article, wherein the evaluation comprises determining at least one characteristic of the 3D crystalline article and storing the results of the evaluation in a knowledge database.

In various embodiments, a computer program product for printing a 3D crystalline article is provided. The computer program product comprises a computer readable storage medium having program instructions embodied therewith. The program instructions executable by a processor to cause the processor to read a specification of a material and a desired crystalline structure, dispense, by a nozzle, a layer of the material, determine, by a plurality of materials characteristic sensors, at least one characteristic of the dispensed layer, select a plurality of seed crystals based on a compatibility with the at least one characteristic of the dispensed layer. The compatibility corresponds to an ability of the plurality of seed crystals to produce the desired crystalline structure. The plurality of seed crystals are deposited onto a surface of the layer of material by a robotic arm, thereby producing a portion of the 3D crystalline article.

In various embodiments, the program instructions executable by a processor further cause the processor to deposit the plurality of seed crystals in a pattern and using a timing sequence that produces the desired crystalline structure in the layer of material.

In various embodiments, the program instructions executable by a processor further cause the processor to continuously monitor a crystal formation pattern of the 3D crystalline article during its formation.

In various embodiments, the program instructions executable by a processor further cause the processor to select a type of the plurality of seed crystals from a knowledge database of suitable seed crystal types, wherein the knowledge database comprises data collected from previously printed 3D crystalline articles.

In various embodiments, the program instructions executable by a processor further cause the processor to provide a recommended specification for printing a subsequent 3D crystalline article based on the data collected from previously printed 3D crystalline articles stored in the knowledge database.

In various embodiments, the program instructions executable by a processor further cause the processor to evaluate the 3D crystalline article, wherein the evaluation comprises determining at least one characteristic of the 3D crystalline article and store the results of the evaluation in a knowledge database.

### BRIEF DESCRIPTION OF THE DRAWINGS

FIG. 1 depicts a front view of an exemplary 3D printing device and seed crystal robotic arm system, in accordance with various embodiments of the present disclosure.

FIG. 2 depicts a block diagram of an exemplary movement control system, in accordance with various embodiments of the present disclosure.

FIG. 3 depicts a flowchart of an exemplary method for constructing a crystalline 3D printed article, in accordance with various embodiments of the present disclosure.

FIG. 4 depicts a block diagram of an exemplary seed crystal selection unit, in accordance with various embodiments of the present disclosure.

FIG. 5 depicts a graphic of an exemplary U-Net system that may be used to determine regions for the introduction of a plurality of seed crystals, in accordance with various embodiments of the present disclosure.

FIG. 6 depicts a graphic of a regression diffusion model for determining an ideal seed crystal configuration, in accordance with various embodiments of the present disclosure.

FIG. 7 depicts a block diagram of an exemplary quality evaluation unit, in accordance with various embodiments of the present disclosure.

FIG. 8 depicts a flowchart of an exemplary method for selectively 3D printing a crystalline article, in accordance with various embodiments of the present disclosure.

FIG. 9 depicts a communication processor/computing node, in accordance with various embodiments of the present disclosure.

### DETAILED DESCRIPTION

3D printing is an established method for the manufacture of various types of articles. During the 3D printing process, liquid and semi-liquid materials are deposited layer by layer and are allowed to gradually solidify into a desired shape/structure. However, controlling the formation of the crystalline structure of a 3D printed article can be challenging. 3D printed articles with crystalline structures that include defects or flaws can result in articles which are brittle and short-lasting. Thus, there is a need in the art for a methods, systems, and computer program products that enable the programmable control of the crystallization of a 3D printed article.

Crystal seeding is one such technique for controlling the crystal structure of 3D printed articles. Crystal seeding is the process of adding homogeneous or heterogeneous crystals to a crystallizing solution to nucleate and/or grow more crystals. A seed crystal is a small piece of single crystal or polycrystal material taken from a large crystal of the same material. The use of crystal seeding to promote growth may prevent the otherwise slow randomness of natural crystal growth and allows for manufacture on an industrial scale. By controlling the size distribution and polymorphism of crystals that are formed, product reproducibility between batches and/or over time can be ensured.

While crystal seeding has been demonstrated to be an effective method for controlling the crystallization pattern and size of a material, the correct seed loading (mass) and seed size may need to be chosen. In considering a theoretical crystallization system where only growth occurs and crystals are spherical, it may be possible to develop a simple model where final crystal size can be predicted based on the starting seed size and loading. In a case where an 3D printed article includes a crystallization with 1% seed, 1% may be the ratio of seed mass to the final anticipated product mass. Because the seed and final product have identical density, it may be possible to convert a mass ratio to a volume ratio, and then from a volume ratio to a diameter ratio. The present disclosure makes use of these findings to produce a reliable and accurate methods, systems, and computer program products for selectively controlling the crystallization of 3D printed articles.

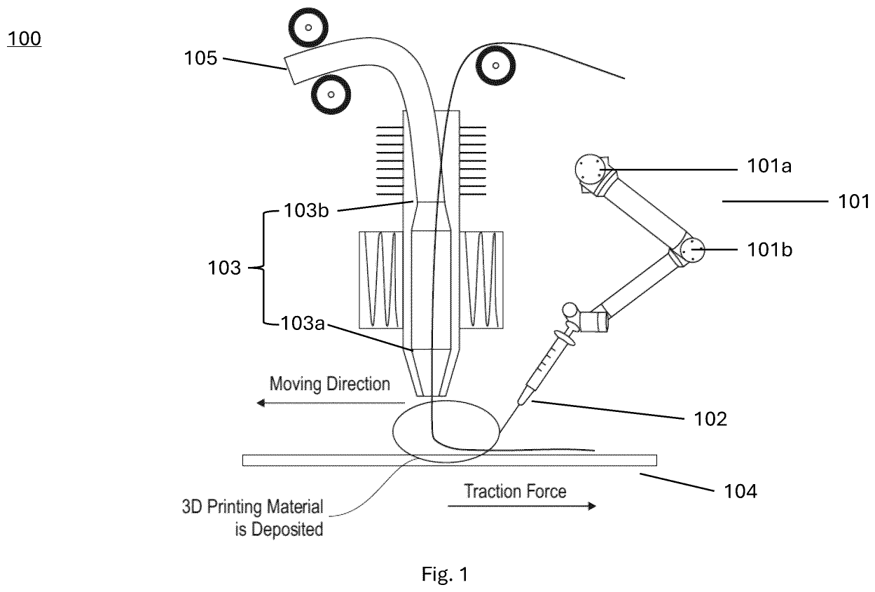

Referring now to FIG. 1 a system 100 of an exemplary 3D printing device and seed crystal robotic arm is depicted.

As shown in FIG. 1, the selectively controllable crystallized 3D printing system 100 includes a 3D printing device 103. The 3D printing device 103 may comprise an elongated hose 103b with a tapered nozzle 103a disposed at the distal end of the elongated hose. A 3D printing material source (not shown) may be located at the end of the elongated hose opposite to the tapered nozzle. The 3D printing material source may contain various materials, according to preferences of a user of the system 100. In various embodiments, the 3D printing material source may be capable of holding one or more extrudable materials, such as extrudable polymer, ceramic, metallic materials, and/or the like. A 3D printing device movement mechanism 105 may be operably connected to the 3D printing device 103. In various embodiments, the 3D printing device movement mechanism 105 may include a conveyor belt mechanism with a motor and drive pulley. In various embodiments, the 3D printing device may be moved by any other suitable movement mechanism known in the art.

A platform 104 may be positioned below the opening of the 3D printing nozzle 103a for supporting an article that is printed. In various embodiments, the platform 104 may be stationary. In various embodiments, the platform 104 may be moveable.

The 3D printing device and seed crystal robotic arm system 100 may further include a robotic arm 101, which may be positioned adjacent to the 3D printing device 103. The robotic arm 101 may include a plurality of joints 101a, 101b for enabling movement in the X, Y, and Z directions. The distal end of the robotic arm 101 may include an end-effector 102. The end-effector 102 may include any suitable structure for lifting a seed crystal. For example, and without limitation, the end-effector 102 may be a syringe. As another example, the end-effector 102 may be a claw.

In operation, the 3D printing device 103 may be configured to print an article specified by a user of the system 100. As the nozzle moves in one direction and deposits a material on the platform, a traction force is produced in the opposite direction. The robotic arm 101 may be controlled to move with the 3D printing device 103 such that as the 3D printing nozzle 103a deposits material, and the end-effector 102 may place seed crystals in the appropriate locations on the deposited material. The robotic arm 101 may be actuated to move by any suitable means. In various embodiments, the robotic arm 101 may be actuated to move by a stepper motor. In various embodiments, the robotic arm 101 may be actuated to move by an air cylinder.

In various embodiments, the robotic arm 101 may be actuated to move and place crystals seeds after the 3D printing device 103 concludes the deposition of a layer of material. In various embodiments, the robotic arm 101 may be actuated to move and place seed crystals as the 3D printing device 103 is depositing a layer of material.

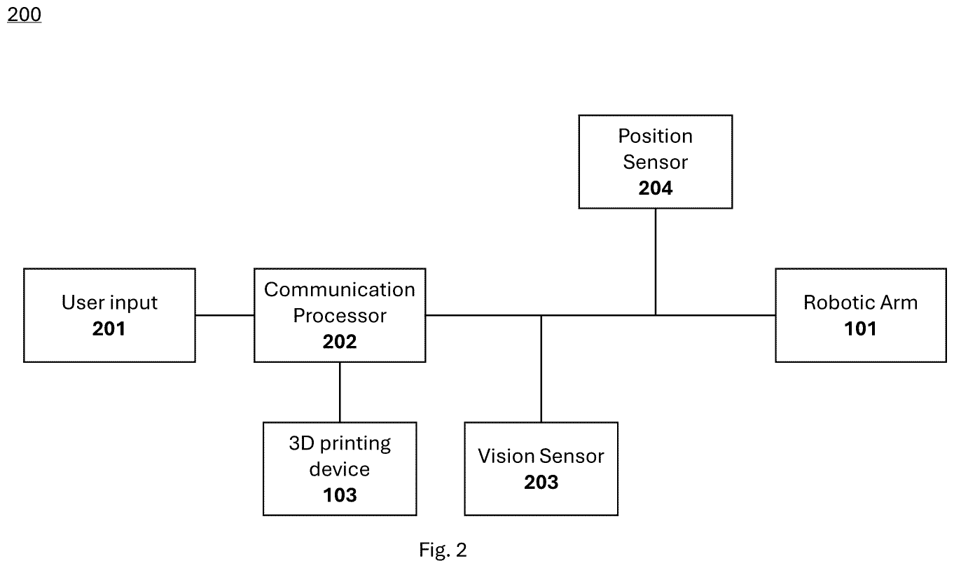

Referring to FIG. 2, a block diagram of a movement control system 200 is depicted. The movement control system 200 may control the robotic arm 101 and 3D printing device 103 such that both move autonomously once instruction is set by a user specifying the 3D printing material type and desired crystalline structure. The user may input information regarding the desired 3D printing process via a user input device 201. The user input device may comprise any suitable means for allowing a user to enter information into the robotic arm control system 200. For example, and without limitation, the user input device 201 may include a touchscreen, control panel with buttons, or LED array. In various embodiments, the user input device 201 may include a mobile device or personal computer which is operably synced with the 3D printing device 103, seed crystal robotic arm 101, and/or the system 200.

The robotic arm movement control system may further include a position sensor 204 and vision sensor 203. In various embodiments, both sensors, 203 and 204, may be mounted on the robotic arm 101. In various embodiments, both sensors, 203 and 204, may be mounted on a frame of the 3D printing system 100. In various embodiments, one sensor may be mounted on a frame while the other is mounted on the robotic arm 101. The vision sensor 203 may collect information (e.g., images, heat maps) regarding the structure of a 3D printed layer as it is deposited. Further, a position sensor 204 may monitor the position of the 3D printing device 103. The vision sensor 203 may comprise any suitable sensor(s) for capturing images. In various embodiments, the vision sensor(s) may include but are not limited to camera(s), infrared sensor(s), and/or any other optical sensor(s). The position sensor 204 may comprise any suitable sensor(s) for sensing the position of the 3D printing device 103. In various embodiments, the position sensor(s) may include but are not limited to optical proximity sensor(s), ultrasonic sensor(s), piezo-electric transducer(s), hall sensor(s), and/or any other position sensor(s). The robotic arm control system 200 may further be configured to send and receive information and instructions from a communication processor 202. The communication processor 202 may be operably connected to the user input device 201, position sensor 204, vision sensor 203, 3D printing nozzle 103, and/or robotic arm 101. In various embodiments, the communication processor 202 may be a microcontroller and/or a computer, such the computing node described herein. In various embodiments, the communication processor 202 may include any other suitable device that may perform processing and/or communication.

In operation, the user may select a desired 3D printing material and crystalline structure for a given article on the user input device 201. The user input device 201 may then relay the user-specified information to the 3D printing device 103, which may begin to deposit layers of the selected material onto the platform 104 into the appropriate shape and structure. As the 3D printing device 103 is moved and controlled to deposit material, the position sensor 204 and vision sensor 203 may continuously or periodically sense the position of the 3D printing device and the shape and structure of the deposited layer. The sensed information may be relayed to the communication processor 202. The communication processor 202 may actuate the robotic arm 101 to move in order to avoid collision with the 3D printing device 103 and to place one or more seed crystals in the appropriate locations.

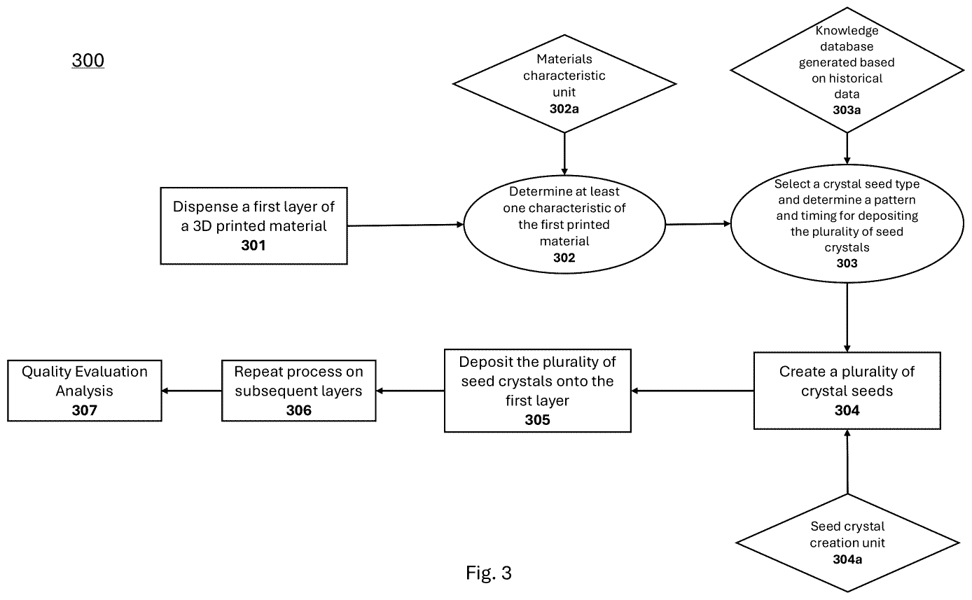

Referring now to FIG. 3, a flowchart of an exemplary method 300 for constructing a crystalline 3D printed article is depicted. In various embodiments, the user may specify/select a type of material to be printed and/or the material's preferred crystalline structure for the 3D printed article. The type of material may be a polymer material, a ceramic material, a metal material, and/or any other 3D printing material. As examples, the user may select between a simple cubic, body-centered cubic, face-centered cubic, or hexagonal close-packed crystalline structures when depositing a metallic material. As further examples, the user may select between types of ionic or covalent network crystalline structures when depositing a ceramic material. As further examples, the user may select between different types of molecular structures when depositing a polymeric material. Once the printing specifications are selected by the user, the 3D printing device 103 may dispense a first layer of material according to preferences set by a user at step 301.

As the first layer of material is deposited, a materials characteristic unit 302a may sense the mechanical and structural properties of the deposited layer at step 302. For example, and without limitation, the materials characteristic unit 302a may sense properties, such as the thermal expansion, melting point, viscosity, and/or the like, of the dispensed material. The materials characteristic unit 302a may do so via a plurality of materials characteristic sensors mounted within the material source, the 3D printing nozzle, or any other suitable location.

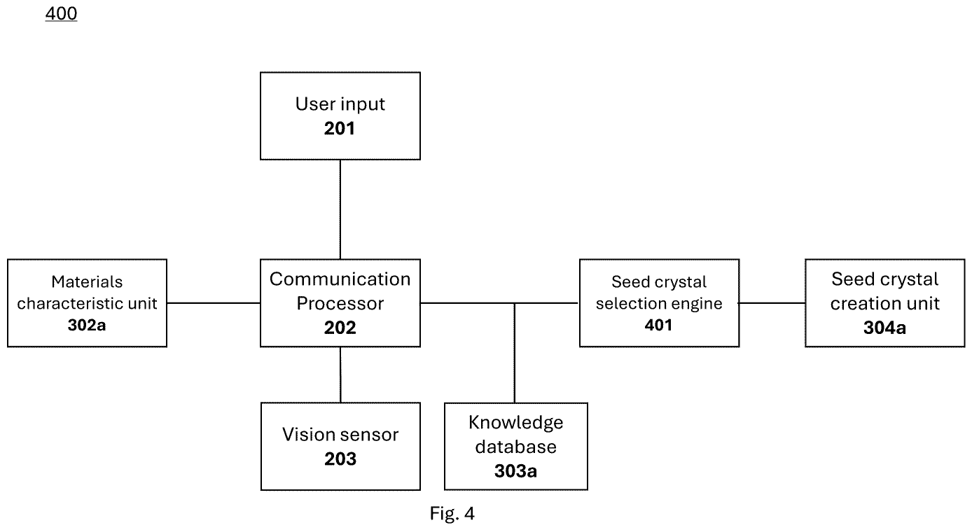

Based on the sensed information along with information from a knowledge database 303a, a seed crystal type may be selected and a pattern for depositing and/or a timing sequence may be determined for deposition onto the 3D printed material layers at step 303 by a seed crystal selection unit, as shown and described with relation to FIG. 4 below. The timing sequence may refer to the speed and rate at which seed crystals are deposited onto a layer of 3D printing material. In various embodiments, the knowledge database 303a may be a pre-populated, database based on historical data that includes information regarding various seed crystals, 3D printing materials, their properties, and the interactions between the seed crystal types and various 3D printing materials. In various embodiments, the selected seed crystal may possess properties aligned with the desired properties of the 3D printing material. As examples, and without limitation, these properties may include a hardness, a thermal conductivity, an electrical conductivity, and/or any other properties. In various embodiments, any suitable properties of the 3D printing materials may be analyzed. Compatibility may be defined as the ability of the plurality of seed crystals to produce the desired crystalline structure when deposited onto a 3D printed material layer. Compatibility between a seed crystal type and a 3D printing material may be determined by comparing properties between the two. These properties may include a lattice structure, a surface energy, a chemical reactivity, and/or any other properties, between the two. In various embodiments, any other suitable properties may be analyzed and/or compared in order to select a seed crystal.

In various embodiments, the knowledge database 303a may include historical data from previous crystallized 3D printing processes. Using this historical data, a suitable size and shape for the selected seed crystal may be determined. The size and shape of the seed crystal may be selected such that controlled and consistent nucleation of the crystallized 3D printed article is promoted. Historical data may also be used to determine a timing sequence in which the seed crystal is deposited on a 3D printed layer. In various embodiments, the seed crystals may be deposited on the 3D printing material immediately after the material is extruded. In various embodiments, the seed crystals may be deposited on the 3D printed material after a pre-determined period of time passes. In various embodiments, various seed crystals may be deposited on the 3D printed material layer in a defined geometrical pattern and/or in a defined timing sequence.

In various embodiments, the knowledge database 303a may include information regarding suitable crystal modification techniques that would be suitable for different 3D printing materials. Such information may be used to determine surface treatment techniques that may enhance a seed crystal's affinity to the 3D printing material. Such processes may include but are not limited to coating or functionalization techniques.

Once a suitable seed crystal is chosen, at step 304, a seed crystal creation unit 304a may then create a plurality of seed crystals with the appropriate properties as determined by the materials characteristic unit 302a. The seed crystal creation unit 304a may produce the seed crystals as determined at step 303 through a variety of means. For example, and without limitation, the seed crystal creation unit 304a may implement techniques, such as vapor deposition, solid-state reactions, solution crystallization, and/or other similar techniques, to generate seed crystals. Any suitable instrumentation and/or materials required for carrying out such processes may be provided in the necessary configurations in the seed crystal creation unit 304a. For example, in a seed crystal creation unit where vapor deposition is implemented to generate a seed crystal, the unit may include a reaction chamber, appropriate precursor gases, heating elements, an energy source, an exhaust system, etc.

At step 305, the plurality of generated seed crystals may be placed onto the surface of the first deposited layer in a pattern and at a timing sequence as previously determined at steps 303 and 304. After depositing the appropriate seed crystals onto a 3D printed layer, the process may be repeated for subsequent layers at step 306. In various embodiments, the materials characteristic unit 302a may continuously sense the characteristics of a dispensed layer of 3D printing material to record the crystal formation pattern in development. At the end of the 3D material printing process, at step 307, a quality evaluation analysis may be carried out on the resulting structure of the 3D printed article. The quality evaluation analysis 307 may measure quality attributes of the final crystallized, 3D printed article, which may include but are not limited to the mechanical strength, a thermal conductivity, and a surface finish. In various embodiments, different quality attributes as specified by a user of the systems described herein may be measured in the quality evaluation analysis 307. A variety of sensors may be positioned at different locations surrounding the 3D printed structure. These sensors may sense the quality attributes of the completed article and relay them back to a knowledge database, such as knowledge database 303a, for storage as historical data. In this manner, the knowledge database may be “writable”, meaning that as the crystallized 3D printing system completes more articles, the knowledge database may grow larger. Subsequent processes would rely on the enlarged knowledge database and would ideally be more accurate as a result of the enlarged knowledge database being used in the selection of seed crystals. This can result in more stable 3D printed crystalline articles being produced.

Referring to FIG. 4, a block diagram of an exemplary seed crystal selection unit 400, is depicted.

The seed crystal selection unit 400 may operate based on information gathered from various components in a crystallized 3D printing system, such as crystalized 3D printing system 100. A materials characteristic unit 302a including a plurality of materials characteristic sensors may be mounted around a 3D printing device, such as 3D printing device 103, to monitor the characteristics of deposited material. As discussed above, the materials characteristic sensors may include but are not limited to thermal expansion sensor(s), melting point sensor(s), viscosity sensor(s), and/or any other material sensor(s). In various embodiments, the materials characteristic unit 302a may be mounted inside a housing for the materials. The materials characteristic unit 302a may be actuated to sense the material characteristics when a user selection is made. In various embodiments, the materials characteristic unit 302a may be mounted around the tip of the 3D printing nozzle, such as 3D printing nozzle 103a, to sense material properties as material is extruded. In various embodiments, the materials characteristic unit 302a may be mounted between the material source and tip of the nozzle. In operation, the sensed properties of the extruded material may be relayed from the materials characteristic unit 302a to the communication processor 202.

The vision sensor 203, as described herein, may be mounted at a position to capture images of each 3D printed layer. In various embodiments, the vision sensor 203 may be mounted on the robotic arm 101. In various embodiments, the vision sensor 203 may be mounted on the frame of the 3D printing assembly of 3D printing system 100. In various embodiments, the vision sensor 203 may comprise any suitable sensor for capturing images. In operation, the information recorded by the vison sensor 203 may be relayed to the communication processor 202.

The communication processor 202 may receive information from the materials characteristic unit 302a, including a plurality of materials characteristic sensors, and vision sensor 203. Information regarding the characteristics of the layers of 3D printed material may be stored by the communication processor 202 and used to control other components in the 3D printing assembly. In operation, the materials characteristic sensors of the materials characteristic unit 302a may sense information about the 3D printing material (e.g., its structure, material characteristics, etc.). This information may then be relayed to the communication processor 202, which then may use the information to adjust the functions of other components in the assembly, such as the robotic arm 101 or the seed crystal selection engine 401, as described herein. The communication processor 202 may send and receive information to and from any components associated with the systems described herein.

The seed crystal selection unit 400 may additionally utilize information from the knowledge database 303a, as described herein. As described herein, in various embodiments, the knowledge database 303a may include information about characteristics of the completed 3D printed crystalline article. In various embodiments, the knowledge database 303a may include information about the mechanical strength, a thermal conductivity, and/or a surface finish of the completed 3D printed crystalline article. In an illustrative example, a higher mechanical strength of a completed 3D printed article may indicate that the 3D printing material and the selected seed crystal used for that finished 3D printed article are more compatible than the material and crystal used for printing a 3D article that exhibits a lower mechanical strength.

The knowledge database 303a may be supplemented with additional information each time a 3D printing process is completed. A writeable knowledge database 303a may present multiple benefits. For example, the knowledge database 303a may become larger as more information is added to it, and a larger database may present trends and correlations of greater statistical significance. A machine learning model, such as a neural network, may be used to analyze the knowledge database and determine suitable seed crystal parameters, as discussed herein. In various embodiments, having a larger database, such as one containing a greater amount of relevant information, may allow for more accurate training of a machine learning model.

The seed crystal selection unit 400 may include a seed crystal selection engine 401, which may be a server, a personal computer, a mainframe, a cluster of computing devices, a mobile device such as a smartphone, or some other suitable computing device. The seed crystal selection engine 401 may be adapted to determine a suitable seed crystal type, seed crystal size, and/or timing sequence for depositing the seed crystals based on the characteristics of the 3D printing material and/or the user's preferences.

The seed crystal selection engine 401 may determine a suitable seed crystal type, size of the seed crystals, and deposition timing sequence for the seed crystals using a machine learning (ML) model, such as a neural network, which implements one or more ML techniques. The ML model may do so by using the characteristics of the 3D printing material, captured images of the 3D printed layers, and the knowledge database 303a. As shown in FIG. 4, the seed crystal selection engine 401 may receive information from a user input device 201 regarding the desired crystalline structure of the completed article via the communication processor 202. The engine 401 may also receive information from the materials characteristic unit 302a regarding the characteristics of the 3D printing material via the communication processor 202. Such information may be used in conjunction with the pre-stored data and historical quality evaluation information, such as what is stored in the knowledge database 303a, to determine which seed crystal type may be suitable based on the 3D printing material and the preferred crystalline structure. Thus, the seed crystal selection engine 401 may select seed crystals based on new information in every run, resulting in increased accuracy and more structurally stable printed articles.

In various embodiments, the seed crystal selection engine 401 can be wholly or partially combined with the communication processor 202 in a single component. For example, the single component may receive information from materials characteristic unit 302a, a user input device, and knowledge database 303a in order to determine suitable seed crystal types, seed crystal sizes, and deposition timing sequences and/or pattern for the seed crystals. Once this crystal type, size, deposition timing sequence and/or pattern information are determined, this information may be sent to a seed crystal creation unit 304a.

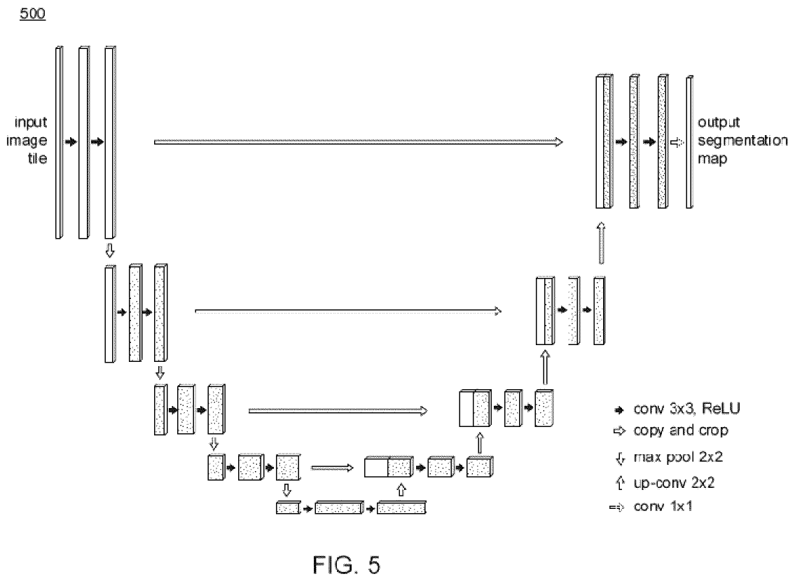

Referring now to FIG. 5, a graphic of an exemplary U-Net system 500 that may be used to determine regions for the introduction of a plurality of seed crystals is depicted. A U-Net system may be a convolutional neural network (CNN) that may be used for image processing tasks, such as image segmentation. A U-Net system, such as the U-net system 500, may be a supporting computer vision process/ML model for the seed crystal selection engine 401. The functions of the U-Net system may allow the seed crystal selection engine 401 to determine the proper placement of seed crystals on a 3D printed layer. In operation, various images of a 3D printed layer be transmitted from the vision sensor and materials characteristic sensors as shown and described with relation to FIG. 4 to the communication processor 202 and to the seed crystal selection engine 401. Through an encoder/decoder system, a U-Net system of the seed crystal selection engine, such as U-Net system 500, may predict where various features are located in each of one or more captured images, such as from the vision sensor, and which features are in the images. A set of images may be classified, and object localization may be carried out by the U-Net system. In various embodiments, bounding boxes may be created around general locations of interest within image by the U-Net system. Objects/features may be further detected by the U-Net system to differentiate the number of features within the bounding boxes. A mask may then be generated by the U-Net system for each group of features detected within an image, and multiple masks may be generated to discern between different feature types within a mask.

In operation, the U-Net system of the seed crystal selection engine 401, such as U-Net system 500, may identify locations where placement of a seed crystal would be suitable in accordance with the type of 3D material printed and the desired crystalline structure of the completed article. For example, the seed crystal selection engine, using the U-Net system, may identify regions including specific positions where the placement of seed crystals would achieve the desired crystalline structure of the completed article. The U-Net system may use the images captured from the vision sensor along with the materials characteristics of the dispensed 3D printing material and various seed crystal types, such as the temperature, viscosity, melting point, thermal expansion, and/or formation pattern of the 3D printing material, the desired crystallization structure, seed crystal hardness, and/or seed crystal thermal/electrical conductivity, to determine seed crystal placement positions. The U-Net system may also consider the rate of nucleation, rate of growth of the seed crystal, and/or the time required for the seed crystal to achieve controlled growth. Once proper positions are determined for depositing the seed crystals on a 3D printed layer, the seed crystal selection engine may relay such seed crystal information to the communication processor 202. The communication processor 202 may transmit the seed crystal information to the seed crystal creation unit, where proper seed crystals are generated. Based on this seed crystal information, the communication processor 202 may control the robotic arm and effector to grasp and place seed crystals in their appropriate locations on the surface if a 3D printed layer.

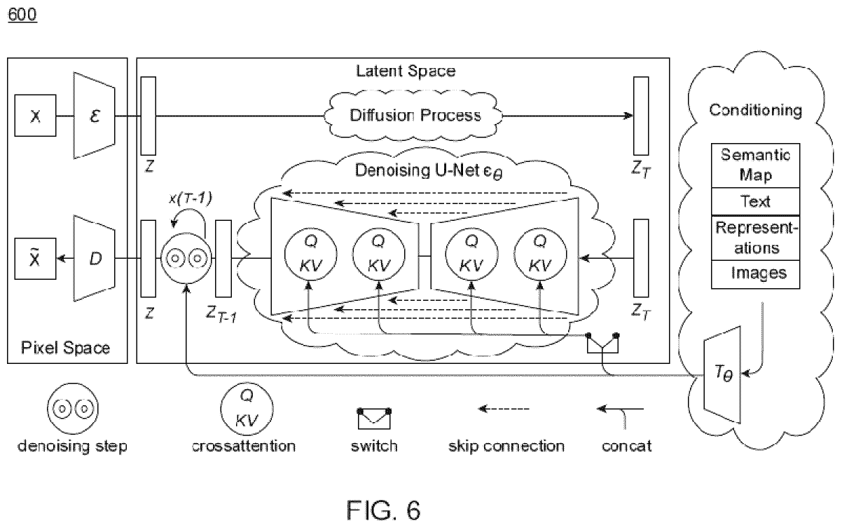

Referring to FIG. 6, a graphic of a regression diffusion model 600 for determining an ideal seed crystal configuration is depicted. Captured data from the materials characteristic sensors, such as from the materials characteristic unit 302a, may contain fluctuations and/or noise. Images captured by the vision sensor 203 may also contain noise as random variations in pixel values which may appear as grain or speckles. In other words, the sensor output and image data may include fluctuations and/or noise that are unrelated to the input data. In order to “clean up” the data captured by the materials characteristic sensors and vision sensor, a regression diffusion model 600 may be included as a secondary computer vision technique used by the seed crystal selection engine 401.

In operation, the materials characteristic unit may sense information, such as characteristics, related to, but not limited to, the thermal expansion, melting point, viscosity, and/or any other characteristics, of the dispensed material. The vision sensor may capture images of the structure of the dispensed 3D printing material during the 3D printing process. This captured information may be transmitted to the seed crystal selection engine 401 by the communication processor 202. Such captured information by the sensors may contain fluctuations and/or noise. For example, the fluctuations and/or noise may be caused by environmental conditions, degradation of sensor(s) over time, and/or simply due to poor quality of the sensor(s). The captured information may be passed to the regression diffusion model 600 where unusual or unexpected fluctuations and/or noise may be eliminated, generating a more cohesive data set. In various embodiments, the elimination of fluctuations and/or noise in data sets may result in more accurate determinations of the amount of seed crystal necessary. In operation, a regression diffusion model, such as regression diffusion model 600, may receive sensor data x from the materials characteristic unit 302a and/or the vision sensor 203. An encoder & may gradually add more noise to the received data x, converting it into a low dimensional latent representation Z_{T} in a diffusion process. The low dimensional latent representation Z_{T} may then be passed to a decoder D. The decoder D may carry out a reverse diffusion step. During the reverse diffusion step the decoder D may also receive any text, additional images, representations, or semantic maps. For example, when a user specifies a desired crystalline structure through a user input device, the decoder D may use the user supplied information T_{θ} (which may be in the form of text or images), in constructing denoised data in the reverse diffusion step. The reverse diffusion step may include a concat, skip connections, a switch, and crossattentions within a denoising U-Net system ∈_{θ}. These features may aid in connecting image layers which are not adjacent to one another, enabling the regression diffusion model to translate and prioritize the data passed to it, and storing multiple parts of data efficiently. During a denoising step, resulting data \tilde{x} may be predicted through the following simplified weighted bound:

$${E}_{ε ( x ) , ϵ} ∼ N ( 0 , 1 ) , t [ {‖ ϵ - {ϵ}_{0} ( {z}_{t} , t ) ‖}_{2}^{2} ]$$

with t uniformly sampled from [1, . . . , T], where E is the expected value, and N is the normal distribution.

In this process, the model may be realized as a time-conditional U-Net system and the resulting data \tilde{x} may be obtained from the decoder D in a single pass. The resulting data \tilde{x} obtained from the regression diffusion model may be free of noise and/or may depict or represent the selected 3D printing material with the user's desired crystalline structure. For example, vision sensor data passed to the regression diffusion model 600 may be denoised or “cleaned up” such that random variations in pixel values may be eliminated and/or the data may be used to generate an image depicting the 3D printing material in the crystalline structure desired by the user. Materials characteristic sensor data passed to the regression diffusion model 600 may also be rid of random fluctuations and/or may be used to generate data representing the materials characteristics that would be present when the desired crystalline structure of the 3D printed material is achieved.

In various embodiments, the regression diffusion model 600 may be included in the memory of a separate computer processor from the U-Net system. In various embodiments, the regression diffusion model and the U-Net system may be wholly or partially combined in the memory of a single computer processor.

A Runge-Kutta 4 (RK-4) dynamics forecaster (not shown) for determining feature inputs for the U-Net system may also be used to support the computer vision technique used by the seed crystal selection engine 401 In various embodiments, the RK-4 dynamics forecaster may be a part or a portion of the seed crystal selection engine 401. In various embodiments, the RK-4 dynamics forecaster may be used by the seed crystal selection engine 401 to determine the amount of seed crystal necessary to produce an ideal crystallization state of a selected 3D printing material. The RK-4 dynamics forecaster may perform a Runge-Kutta technique to solve a system of ordinary differential equations (ODE) representative of the structural and material characteristics of a 3D printing material and a desired crystalline structure of the 3D printing material. Input variables in the system of ODEs may be obtained from values sensed by the materials characteristic sensors and the vision sensor, and “cleaned up” by the regression diffusion model 600.

Once the regression diffusion model removes sensor fluctuations and/or noise from the captured data sets, the data may be passed to the RK-4 dynamics forecaster. Data captured from each materials characteristic sensor of the materials characteristic unit 302a may represent the change in a measured characteristic over time, which may be used to generate a system of ODEs representative of the phases of crystal growth over time as 3D printing material and seed crystals are deposited. In other words, the system of ODEs may represent the structure and pattern of the 3D crystalline article at different phases of its development. The system of ODEs may also receive a set of user-inputted data regarding the desired crystalline structure of the completed article. Once the “cleaned up” data and user inputted information are used as input into the system of ODEs, the RK-4 dynamics forecaster may solve the system of ODEs to generate the amount of seed crystal necessary to achieve the desired crystalline form. The RK-4 dynamics forecaster may solve the system of ODEs according to a Runge-Kutta technique and/or any other known technique. For example, a Runge-Kutta 4^{th} order technique for solving the system of ODEs, such as one used by the RK-4 dynamics forecaster, may be set up as shown in the following equations:

$${k}_{1} = f ( {t}_{n} , {y}_{n} ) \qquad ( Equation 1 )$$

$${k}_{2} = f ( {t}_{n} + \frac{h}{2} , {y}_{n} + h \frac{{k}_{1}}{2} ) \qquad ( Equation 2 )$$

$${k}_{3} = f ( {t}_{n} + \frac{h}{2} , {y}_{n} + h \frac{{k}_{2}}{2} ) \qquad ( Equation 3 )$$

$${k}_{4} = f ( {t}_{n} + h , {y}_{n} + {hk}_{3} ) \qquad ( Equation 4 )$$

$${y}_{n + 1} = {y}_{n} + \frac{h}{6} ( {k}_{1} + 2 {k}_{2} + 2 {k}_{3} + {h}_{4} ) \qquad ( Equation 5 )$$

$${t}_{n + 1} = {t}_{n} + h \qquad {( Equation 6 )}^{}$$

In these equations, h is a step size, which may be, 0.1 or 0.01, for example. yₙ is the value read by a materials characteristic sensor at time t₀. In addition, k₁ is the slope of the data measured from a materials characteristic sensor over a period of time (e.g., the period of time to 3D print a layer of the desired article); k₂ is the determined slope of the data at the midpoint of the time interval, using k₁ and yₙ; k₃ is the determined slope of the data at the midpoint of the time interval, using k₂ and yₙ; and k₄ is the determined slope of the data at the end of the time interval, using k₃ and yₙ.

It may be appreciated that, in the aforementioned equations, using a smaller value for h may result in more accurate determinations of the necessary seed crystal amount (e.g., the number of seed crystals and their size) and vice versa. In various embodiments, h may be a value smaller than 0.01 in order to increase the accuracy of the determination of the amount of seed crystal that may be needed. In various embodiments, the value of h may be larger than 0.01in order to increase the speed of the RK-4 dynamics forecaster solver. In various embodiments, a larger value for h may increase the speed of the RK-4 dynamics forecaster solver. In various embodiments, a smaller value for h may decrease the speed of the RK-4 dynamics forecaster solver.

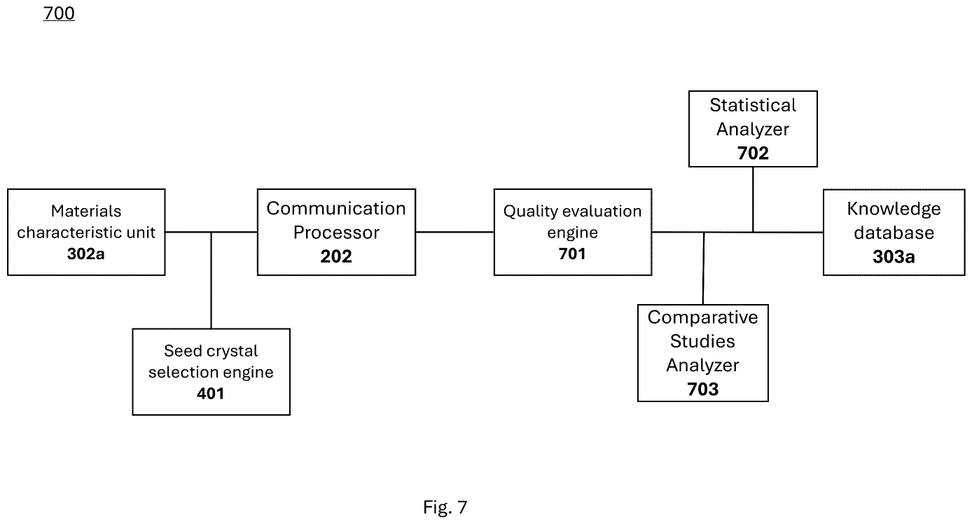

Referring to FIG. 7, a block diagram of an exemplary quality evaluation unit 700 is depicted. Following the completion of a crystallized 3D printing process, the communication processor 202 may transmit a message to a quality evaluation engine 701 to signal that the process is completed. The quality evaluation engine 701 may be a server, a personal computer, a mainframe, a cluster of computing devices, a mobile device such as a smartphone, or some other suitable computing device. The quality evaluation unit 700 may be adapted to implement a structured approach to gather, organize, and analyze data related to a completed printed process. The quality evaluation unit 700 may gather information regarding the quality, user specifications, seeding timing sequence, 3D printing material specification, temperature, fluidity, and external conditions during the printing process.

In operation, the data from the materials characteristic unit 302a may be transmitted to the communication processor 202 during a printing process and/or when these sensors are sensing the characteristics of the 3D printing material as it is being extruded. The sensed information may provide insight into the properties, the composition, and/or the intended use of the selected 3D printing material. A variety of materials characteristic sensors of the materials characteristic unit 302a may be used to capture data once more at the end of the printing process to evaluate the mechanical and/or structural features of the completed article (e.g., mechanical strength, thermal conductivity, and/or surface finish). The communication processor 202 may receive the data captured from the materials characteristic sensors (e.g., the mechanical and/or structural features of the completed article) as well as data regarding the seed crystal type, the number of seed crystals, the size of the seed crystals, and/or deposition timing sequence for the seed crystals and transmit it to the seed crystal selection engine 401. The seed crystal selection engine 401 may transmit information regarding the deposition timing sequence for a printing process to a quality evaluation engine 701 to be analyzed and recorded in a knowledge database 303a.

In various embodiments, the quality evaluation engine 701 may be adapted to analyze chemical interactions between various 3D printing materials and seed crystals. The quality evaluation engine 701 may be capable of analyzing how various 3D printing materials and seed crystals affect the nucleation and crystallization of completed articles. This may further aid in determining which seed crystal properties complement specific 3D printing material properties. The 3D printing system may use instrumentation for evaluating the nucleation and/or the crystallization of the completed 3D printed articles. These may include an electron microscope, optical microscope, scanning probe microscope, dynamic light scattering instrument, small-angle X-ray scattering instrument, X-ray diffractor, laser diffractor, or any other suitable instrumentation for evaluating the nucleation and/or the crystallization of the completed 3D printed articles. The instrumentation for evaluating the nucleation and/or the crystallization of the completed 3D printed articles may produce data related to its evaluation. Data received by the communication processor 202 from the means for evaluating the nucleation and/or the crystallization of the completed 3D printed articles may be transmitted to the knowledge database 303a.

In various embodiments, the quality evaluation engine 701 may be adapted to analyze crystallization kinetics and crystal growth patterns of the various 3D printing materials and seed crystals. The quality evaluation engine 701 may be capable of analyzing how varying environmental temperatures and/or the fluidity of the 3D printing materials affects the crystallization kinetics and crystal growth patterns of completed articles. This may further aid in determining which seed crystal properties complement specific 3D printing material properties. The 3D printing system may use instrumentation for evaluating the crystallization kinetics and/or crystal growth patterns of the completed 3D printed articles. These may include a differential scanning calorimeters, hot-stage microscopes, dilatometers, X-ray scattering instruments, optical microscope, scanning electron microscope, or any other suitable instrumentation for evaluating the crystallization kinetics and/or crystal growth patterns of the completed 3D printed articles. The instrumentation for evaluating the crystallization kinetics and/or crystal growth patterns of the completed 3D printed articles may produce data related to its evaluation. Data received by the communication processor 202 from the means for evaluating the crystallization kinetics and/or crystal growth patterns of the completed 3D printed articles may be transmitted to the knowledge database 303a.

In various embodiments, the aforementioned evaluation instrumentation (e.g., microscopes, calorimeters, diffractors, etc.) may be directly integrated into the crystallized 3D printing system and post-printing quality evaluation may occur autonomously. In various embodiments, this evaluation instrumentation may be mounted separately from the crystallized 3D printing system. In various embodiments, the quality evaluation step may be actuated by a user. For example, a user may interact with the user input device to initiate the quality evaluation step when the printing process has been completed.

Referring to FIG. 7, once the quality evaluation engine 701 receives data from the materials characteristic unit 302a or any other evaluation instrumentation and the seed selection engine, a series of statistical and comparative studies may be carried out. A statistical analyzer 702 may be used to perform a statistical analysis of properties of each of the completed crystallized 3D printed articles to determine how different seed crystal properties impacted the crystallization process and each completed article's final properties. A comparative studies analyzer 703 may be used to evaluate which seed crystal specifications may be most compatible with specific printing materials to achieve desired material properties. Information generated from the statistical analyzer 702 and comparative studies analyzer 703 may then be stored in the knowledge database 303a. In various embodiments, the material, chemical, or mechanical properties analysis of two completed articles printed from the same 3D printing material, but seeded with different crystals, may provide information regarding how certain seed crystals interact with different materials. In such instances, the completed article with a stronger mechanical strength, more preferrable crystallization pattern, and/or more desirable surface finish may indicate that the seed crystal used in that article was more compatible than the other seed crystal. In various embodiments, the amount of seed crystal used and deposition timing sequence of a 3D printing process may be monitored and compared to a completed article's final properties. This analysis may provide information regarding ideal seed crystal amounts and timing sequences. In various embodiments, external environmental conditions may be monitored, and determinations may be made regarding which conditions may be most ideal in order to develop articles with desired properties. In various embodiments, the aforementioned statistical or comparative analyses may be performed on the collected seed crystal deposition and timing sequence data and/or the external conditions during printing.

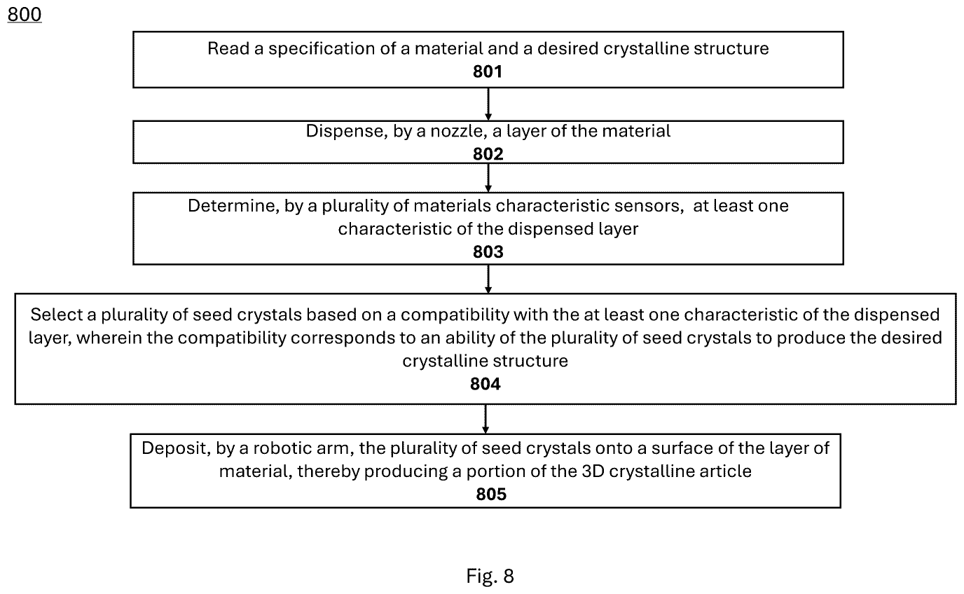

Referring to FIG. 8, a flowchart of an exemplary method 800 for printing a 3D crystalline article is depicted. At step 801, a specification of a material and a desired crystalline structure is read. At step 802, a layer of the material is dispensed by a nozzle. At step 803, a plurality of materials characteristic sensors determine at least one characteristic of the dispensed layer. At step 804, a plurality of seed crystals are selected based on a compatibility with the at least one characteristic of the dispensed layer. The compatibility corresponds to an ability of the plurality of seed crystals to produce the desired crystalline structure. At step 805, the plurality of seed crystals are deposited onto a surface of the layer of material by a robotic arm, thereby producing a portion of the 3D crystalline article.

The operations of the methods presented above are intended to be illustrative. In various embodiments, the method are accomplished with one or more additional operations not described and/or without one or more of the operations discussed. The operations of methods may be performed in another order. Additionally, the order in which the operations of methods are illustrated in FIG. 1-8 and/or described above are not intended to be limiting.

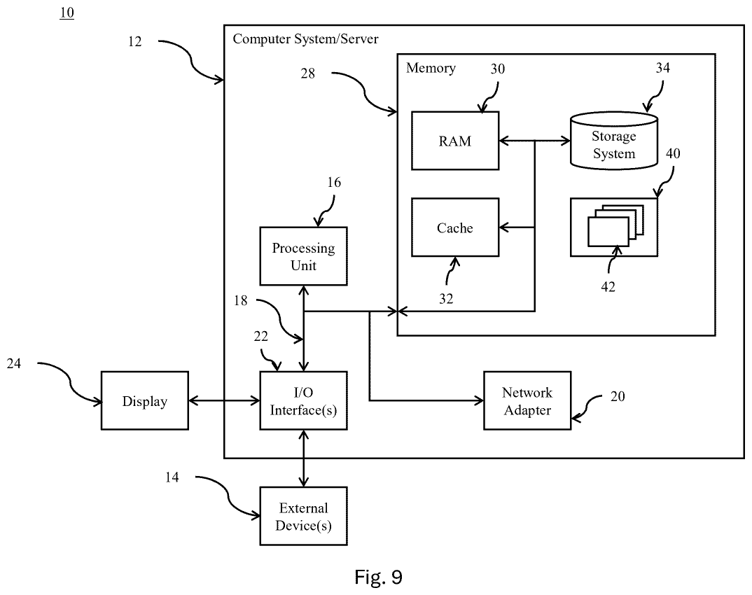

Referring to FIG. 9 a block diagram of an exemplary communication processor is depicted, which may be a may be a portion of (e.g., processor 16) or the entirety of a computer system/server 12. As discussed above, in various embodiments, the methods described above may be implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of methods described above.

The communication processor may transmit information regarding the status of a printing process and/or the quality evaluation results of a completed article through a user input device. In various embodiments, the communication processor may be configured to carry out other suitable tasks. Transmissions to the user input device may be in response to user commands, may be automatic after the elapse of a pre-determined amount of time, or may be actuated at the end of a printing process. In various embodiments, transmissions may be made to the user input device when an error occurs in the printing process and user intervention is required. For example, if the 3D printing nozzle were to become jammed or clogged during the printing process, the communication processor may signal an error message to the user to intervene. In various embodiments, the communication processor may provide recommendations to the user regarding specifications for subsequent runs based on data collected from previous runs through the user input device. For example, these may include suggestions regarding a crystalline structure type based on a selected 3D printing material.

Still referring to FIG. 9, the communication processor may revise information in the knowledge database. As described above, at the end of a printing process, a quality evaluation may be carried out on the completed article. This information may then be transmitted from quality evaluation engine to the communication processor and then to the knowledge database. Subsequent 3D printing processes may then rely on said updated information when selecting seed crystals.

As shown in FIG. 9, the communication processor may be a computer system/server 12 in computing node 10, shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an embodiment of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible embodiments of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative embodiments, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for printing a 3D crystalline article, the method comprising:
reading a specification of a material and a desired crystalline structure;
dispensing, by a nozzle, a layer of the material;
determining, by a plurality of materials characteristic sensors, at least one characteristic of the dispensed layer;
selecting a plurality of seed crystals based on a compatibility with the at least one characteristic of the dispensed layer, wherein the compatibility corresponds to an ability of the plurality of seed crystals to produce the desired crystalline structure; and
depositing, by a robotic arm, the plurality of seed crystals onto a surface of the layer of material, thereby producing a portion of the 3D crystalline article.

2. The method of claim 1, wherein the at least one characteristic of the dispensed layer includes at least one of a thermal expansion, a melting point, and a viscosity.

3. The method of claim 1, wherein depositing the plurality of seed crystals comprises depositing the plurality of seed crystals in a pattern and using a timing sequence that produces the desired crystalline structure in the layer of material.

4. The method of claim 1, further comprising continuously monitoring a crystal formation pattern of the 3D crystalline article during its formation.

5. The method of claim 1, wherein selecting the plurality of seed crystals comprises selecting a type of the plurality of seed crystals from a knowledge database of suitable seed crystal types, wherein the knowledge database comprises data collected from previously printed 3D crystalline articles.

6. The method of claim 5, further comprising providing a recommended specification for printing a subsequent 3D crystalline article based on the data collected from previously printed 3D crystalline articles stored in the knowledge database.

7. The method of claim 1, further comprising:
evaluating 3D crystalline article, wherein the evaluation comprises determining at least one characteristic of the 3D crystalline article; and
storing results of the evaluation in a knowledge database.

8. A system for printing a 3D crystalline article comprising:
a nozzle configured to dispense a layer of a material,
a robotic arm configured to place at least one seed crystal,
a plurality of materials characteristic sensors; and
a computing node, communicatively coupled to the nozzle, the robotic arm, and the plurality of materials characteristic sensors, comprising a computer readable storage medium having program instructions embodied therewith, the program instructions executable by a processor of the computing node to cause the processor to perform a method comprising:
reading a specification of a material and a desired crystalline structure;
dispensing, by the nozzle, a layer of the material;
determining, by the plurality of materials characteristic sensors, at least one characteristic of the dispensed layer;
selecting a plurality of seed crystals based on a compatibility with the at least one characteristic of the dispensed layer, wherein the compatibility corresponds to an ability of the plurality of seed crystals to produce the desired crystalline structure; and
depositing, by the robotic arm, the plurality of seed crystals onto a surface of the layer of material, thereby producing a portion of the 3D crystalline article.

9. The system of claim 8, wherein the at least one characteristic of the dispensed layer includes at least one of a thermal expansion, a melting point, and a viscosity.

10. The system of claim 8, wherein depositing the plurality of seed crystals comprises depositing the plurality of seed crystals in a pattern and using a timing sequence that produces the desired crystalline structure in the layer of material.

11. The system of claim 8, wherein the method further comprises continuously monitoring a crystal formation pattern of the 3D crystalline article during its formation.

12. The system of claim 8, wherein selecting the plurality of seed crystals comprises selecting a type of the plurality of seed crystals from a knowledge database of suitable seed crystal types, wherein the knowledge database comprises data collected from previously printed 3D crystalline articles.

13. The system of claim 12, wherein the method further comprises providing a recommended specification for printing a subsequent 3D crystalline article based on the data collected from previously printed 3D crystalline articles stored in the knowledge database.

14. The system of claim 8, wherein the method further comprises:
evaluating the 3D crystalline article, wherein the evaluation comprises determining at least one characteristic of the 3D crystalline article; and
storing results of the evaluation in a knowledge database.

15. A computer program product for printing a 3D crystalline article, the computer program product comprising a computer readable storage medium having program instructions embodied therewith, the program instructions executable by a processor to cause the processor to:
read a specification of a material and a desired crystalline structure;
dispense, by a nozzle, a layer of the material;
determine, by a plurality of materials characteristic sensors, at least one characteristic of the dispensed layer;
select a plurality of seed crystals based on a compatibility with the at least one characteristic of the dispensed layer, wherein the compatibility corresponds to an ability of the plurality of seed crystals to produce the desired crystalline structure; and
deposit, by a robotic arm, the plurality of seed crystals onto a surface of the layer of material, thereby producing a portion of the 3D crystalline article.

16. The computer program product of claim 15, wherein the program instructions executable by a processor further cause the processor to:
deposit the plurality of seed crystals in a pattern and using a timing sequence that produces the desired crystalline structure in the layer of material.

17. The computer program product of claim 15, wherein the program instructions executable by a processor further cause the processor to:
continuously monitor a crystal formation pattern of the 3D crystalline article during its formation.

18. The computer program product of claim 15, wherein the program instructions executable by a processor further cause the processor to:
select a type of the plurality of seed crystals from a knowledge database of suitable seed crystal types, wherein the knowledge database comprises data collected from previously printed 3D crystalline articles.

19. The computer program product of claim 18, wherein the program instructions executable by a processor further cause the processor to:
provide a recommended specification for printing a subsequent 3D crystalline article based on the data collected from previously printed 3D crystalline articles stored in the knowledge database.

20. The computer program product of claim 15, wherein the program instructions executable by a processor further cause the processor to:
evaluate the 3D crystalline article, wherein the evaluation comprises determining at least one characteristic of the 3D crystalline article; and
store results of the evaluation in a knowledge database.
